(19) United States
(12) Patent Application Publication
(10) Pub. No.: US 2022/0156307 A1
(43) Pub. Date: May 19, 2022

(54) TEMPORAL MULTI-FACTOR RATING AND DATA VISUALIZATION SYSTEM

(71) Applicant: Rapchr, LLC, Brooklyn, NY (US)

(72) Inventors: Jensen Bouzi, Douglaston, NY (US); Malcolm Bouzi, Brooklyn, NY (US)

(21) Appl. No.: 16/950,265

(22) Filed: Nov. 17, 2020

(51) Int. Cl. G06F 16/44; G06F 16/23; G06F 16/26; G06F 16/9536; G06F 16/9535; G06F 16/48; G06F 16/9538

(52) U.S. Cl. CPC G06F 16/44; G06F 16/2379; G06F 16/26; G06F 3/04847; G06F 16/9535; G06F 16/48; G06F 16/9538; G06F 16/9536

(57) ABSTRACT

A data analysis and social media platform is described for receiving and displaying user ratings covering a subject according to a predetermined set of parameters. A subject may be a musical artist or performer, and the parameters a series of quantifiable criteria, characteristics, or core skills that fans may already use in everyday conversation to describe and analyze those artists. The platform may encompass a web server, application engine, database engine, and ratings engine that communicate with browser software running on a computing device to track a subject over time. A rating and skillset breakdown of an artist may be presented visually to the user, who may enter their own ratings for these skillsets. Ratings may be made public and presented with visualizations that convey overall characteristics of the data including average overall rating, average rating by skillset, rating frequency, and most recently rated, among others.

### FIELD OF THE INVENTION

Embodiments of the present invention broadly relate to systems and methods for implementing a data analysis and social media platform having an application engine, database engine, and ratings engine, in which parties having an opinion on a particular subject can meet and engage with one another to discuss, debate, and show appreciation for a subject. A data analysis and social media platform is disclosed in which users may rate a subject according to a common and predetermined set of parameters, analyze the ratings of others, and receive metrics and performance data reflecting changes in perception over time.

### BRIEF DESCRIPTION OF THE DRAWINGS

The features and advantages of the present disclosure will be more fully understood with reference to the following detailed description when taken in conjunction with the accompanying figures, wherein:

FIG. 1 is a block diagram showing an overview of a possible logical and architectural implementation of the present system.

FIG. 2 depicts an artist profile page, as presented on the display of a user computing device in an embodiment of the invention.

FIG. 3 depicts a ratings interface, as presented on the display of a user computing device in an embodiment of the invention.

FIG. 4. contains a source code snippet describing the createRatingGroup function.

FIGS. 5 and 6 contain source code snippets describing the formatSubmittedRatings and handleSubmitRating functions, respectively.

FIG. 7 depicts an alternate view of the artist profile page of FIG. 2, as presented on the display of a user computing device in an embodiment of the invention.

FIG. 8 contains an additional code snippet related to the totalUserRatings function that may be used to present skill ratings.

FIGS. 9-10 depict a sample user flow through the rating and visualization features of a user flow through the rating feature, as presented on the display of a user computing device in an embodiment of the invention.

FIGS. 11a-11g show various sample data object schema or definitions for use in an embodiment of the present invention.

FIGS. 12a-12b contain the source code for sample data resolvers that may be used with embodiments of the invention.

### DETAILED DESCRIPTION

A data analysis and social media platform is disclosed in which users may rate a subject according to a common and predetermined set of parameters, analyze the ratings of others, and receive metrics and performance data reflecting changes in perception over time. In a preferred embodiment, the subject may be a musical artist or performer, and the parameters a series of quantifiable criteria, characteristics, or core skills (referred to as skills or skillsets) that fans may already use in everyday conversation to describe and analyze artists.

In embodiments of the invention, a rating and skillset breakdown of an artist may be presented visually to the user, who may enter their own ratings for these skillsets. Ratings may be made public and presented with visualizations that convey overall characteristics of the data including average overall rating, average rating by skillset, rating frequency, and most recently rated, among others. By capturing the time of each rating, data may be gathered and presented showing how opinions of subjects and their work shift and evolve, capturing a unique community sentiment.

In this respect, before examining at least one embodiment of the invention in detail, it is to be understood that the invention is not limited in its application to the details of construction or to the arrangements of the components outlined in the following description or illustrated in the drawings. Also, it is understood that the phraseology and terminology employed herein are for description and should not be regarded as limiting.

While a preferred embodiment is described in connection with a musical artist, the present invention may be used in any environment where it is desirable to track any individual or object over time, with a focus on quantifiable skills or characteristics. For example, embodiments of the present invention are envisioned with movies, books, political figures, travel destinations, service professionals (e.g., physicians, attorneys, accountants), college professors, cars, video games, mobile apps, and beyond.

### System Architecture

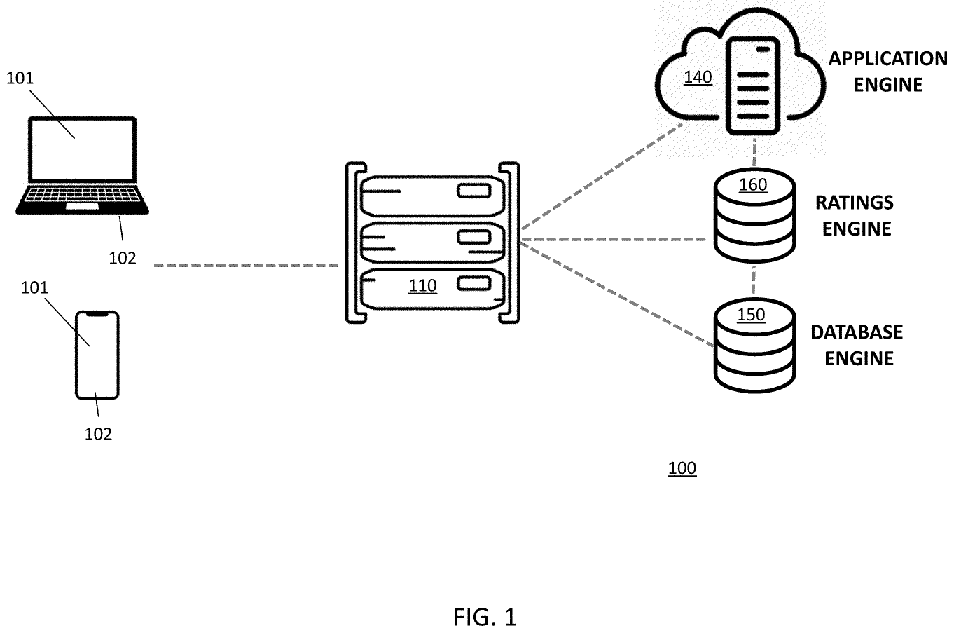

FIG. 1 shows an overview of possible and exemplary architectural implementations for a system 100 according to the present invention with emphasis on where different software functionalities may reside and operate. The user interface for the ratings system 100 of the present invention may be presented to the user in a browser window 101 running on a computing device 102, which may be any form of personal computing device such as, for example, a desktop, laptop, notebook computer, smartphone, tablet computer, smartwatch, etc. The user interface for interacting with the system may appear to the user in a dedicated application or app running on computing device 102. Personal computing device 102 may be capable of querying system components and presenting data to the user visually, and also receiving input from the user.

In embodiments, a web server 110 may comprise hardware and software that is connected to the internet and which allows data to be exchanged—typically via HTTP (Hypertext Transfer Protocol)—with other connected devices, managing how a user accesses hosted files. Web server 110 may thus provide data to the user on computing device 102 comprising login and authentication controls, user interface elements (e.g., buttons, sliders, graphics), content (e.g., artist information, ratings data, user information, timeline data), and other elements of the system that are presented to the user. Similarly, web server 110 may be configured to receive data from the user on computing device 102, such as login and authentication, interaction with user interface elements (e.g., dragging a slider bar to indicate a rating), comments, and other information. In embodiments, web server 110, in combination with browser software running on computing device 102 may be thought of as the front end of the system between the user and the substantive components of the system, including application engine 140, database engine 150, and ratings engine 160. User computing device 102 may connect to the internet to access web server 110 and any other system components needed to implement the functions described herein.

In embodiments of the invention, application engine 140 may comprise or consist of a web server 110 configured to respond to HTTP requests.

An application engine 140 may comprise an application engine and associated storage and manage application operations between the user computing device 102 (via web server 110) and the logic of the system, as embodied in application software running on application engine 140. In embodiments of the invention, application engine 140 may be a cloud-based platform-as-a-service running software that is configured to manage the interaction between computing device 102 and the ratings and database engines (150, 160) described below.

In one embodiment, application engine 140 may be configured to receive API calls from computing device 102, route calls to the appropriate microservice, engage systems services, provide protocol translation, and combine the resulting data into a package for presentation to the user.

In embodiments of the invention, the application engine 140 may be hosted on a cloud platform. It has been found that a service such as Heroku is well-suited for the present invention, providing a managed container system with integrated data services. While a cloud-based system has several advantages—reduced cost, redundancy, ease of setup—the application engine may also be implemented on a local server computing device.

Application engine 140 may comprise storage in the form of a non-transitory computer-readable medium having stored thereon software instructions that, when executed by a processor in an associated server computing device, cause the processor to provide certain system functionality, including, retrieving data from, and storing data in, database engine 150, and ratings engine 160, including historical rating data, artist information, user commentary, and the like. In embodiments, application engine 140 may perform statistical analysis and calculations on data, presenting the same to web server 110 for rendering and presentation to the user. Application engine may manage the storage of ratings data and other system data such subject or user data by database engine 150 and ratings engine 160. Application engine 140 may be configured to store and access ratings data, in cooperation with ratings engine 160 and database engine 150. In embodiments, application engine 140 may also manage digital assets stored by database engine 150 such as album artwork and user avatars.

In embodiments, a ratings engine 160 may be coupled to the application engine over a network and database engine 150 and be configured to store a plurality of data concerning individual user ratings for a particular subject. Ratings engine 160 may perform storage and retrieval tasks, conform data to predefined schema, and perform first-level processing tasks on the data. Ratings engine 160 may be integrated with database engine 150 or may be a separate component that has been optimized for performing the data storage and processing tasks related to ratings data. Ratings engine 160 may be a combination of a server computing device with storage.

In embodiments, a database engine 150 may be provided for storing and organizing data any data related to system function. Database engine 150 may be operatively connected to any of web server 110, application engine 140, or ratings engine 160 and respond to requests to store, retrieve, sort data.

In embodiments, application engine 140 may run background database processing programs, direct making data requests to database engine 150 and parsing or interpreting the results. In embodiments, application engine may execute batch processing request for data on database engine 150.

A database engine 150 may comprise an ORM (object-relational mapping) library may be provided and operatively connected to application engine 140. Database engine 150 provides an abstraction layer that can mask the specifics of the system databases, providing an “automatic API” and an endpoint through which system data may be accessed. By masking the specifics of the systems databases, database engine 150 can facilitate updating, development, or replacement of the system database without modifications to the user-facing side of the system

In embodiments the database layer may comprise a client that is used simplify database access and implement resolvers, which contain logic used to fetch and manipulate data when requests are made by the client. An open-source data query and manipulation language may also be provided, with a runtime for fulfilling queries with existing data.

In a preferred embodiment, a database engine 150 may be hosted on a cloud platform such as Heroku and powered by the Prisma ORM, which is connected to the GraphQL server via the Prisma client. GraphQL is an open-source data query and manipulation language for APIs, and a runtime for fulfilling queries with existing data.

A database engine 150 may be provided in the form of a relational database management system configured to respond to a structured query language.

In a prototype embodiment, a PostgresSQL database was utilized, with a database schema holding all data objects used to implement the ratings system of the present invention.

Database engine may be configured to contain a plurality of data types that have been defined as part of a database vocabulary, and each consisting of system data that may be served to application engine 140 using ratings engine 160 or database engine 150. In embodiments, a plurality of GraphQL schemas may defined to capture aspects of artist rating date stored and analyzed by the system.

### Rating System

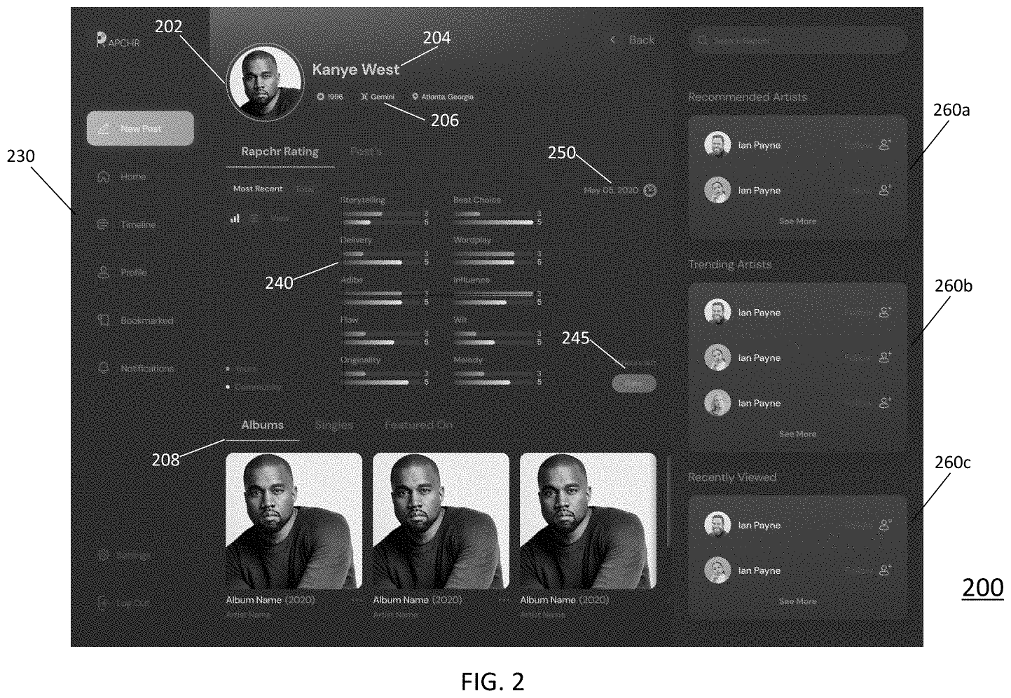

FIG. 2 depicts an exemplary embodiment of an artist profile page, as presented on the display of a user computing device. In this embodiment, the artist profile page may be generated using data retrieved from an application engine and/or ratings engine and rendered by the web server.

Artist profile page 200 may include a plurality of visual, graphical, and textual indicators that provide cues to the user and invitations to engage with the interface to access, input, and sort data relating to the artist. An artist profile may be displayed comprising a photo 202, name 204, and other biographical information 206 such as birth year, astrological sign, and hometown. An artist discography 208 may be displayed and include albums released by the artist and cover artwork, singles released by the artist, and releases where the artist was featured as a guest.

In embodiments, a ratings matrix 240 may be displayed and comprise a list of available ratings vectors with information about user and community ratings for the subject. In the embodiment of FIG. 2, the system has been configured to evaluate musical artists, particularly rap artists, with vectors for “storytelling,” “delivery,” “adlibs,” and other characteristics relevant to a musical performer. Graphical indictors have been provided to show the user's rating in these skillsets compared to the ratings of the community generally, with an integer displayed adjacent the graph.

A date indicator 250 represents the date of the most recent ratings which in this example would be May 5, 2020.

As shown in FIG. 2, as of May 5, 2020, this particular user has assigned to the subject, Kanye West, a “storytelling” rating of 3, whereas the community as a whole awarded an average of 5. In “delivery,” the user again awarded a 3, whereas the community again awarded 5.

It will be appreciated that the ratings system shown in FIG. 2 is one example based on an integer scale of 1-10. The specific ratings scale used may vary and can incorporate other integer scales (e.g., 1-3, 1-5, 1-100), star ratings (e.g., *, **, ***), letter grades, (e.g., A, B, C+), binary values (e.g., thumbs-up, thumbs-down), and the like.

A bookmarks panel 230 may provide navigation options to the user, such as a NEW POST, HOME, TIMELINE, PROFILE, BOOKMARKED ITEMS, and NOTIFICATIONS. Options to access the system settings or to log out are shown beneath bookmarks panel 230.

A recommendations panel 260a-c may be provided to give the user access to recommended artists 260a (i.e., artists that the system has determined are relevant to the user based on a predetermined criteria), trending artists 260b (i.e., artists whose popularity in the community is rising), and recently viewed artists 260c (i.e., artist pages that the user has visited in the near-recent past).

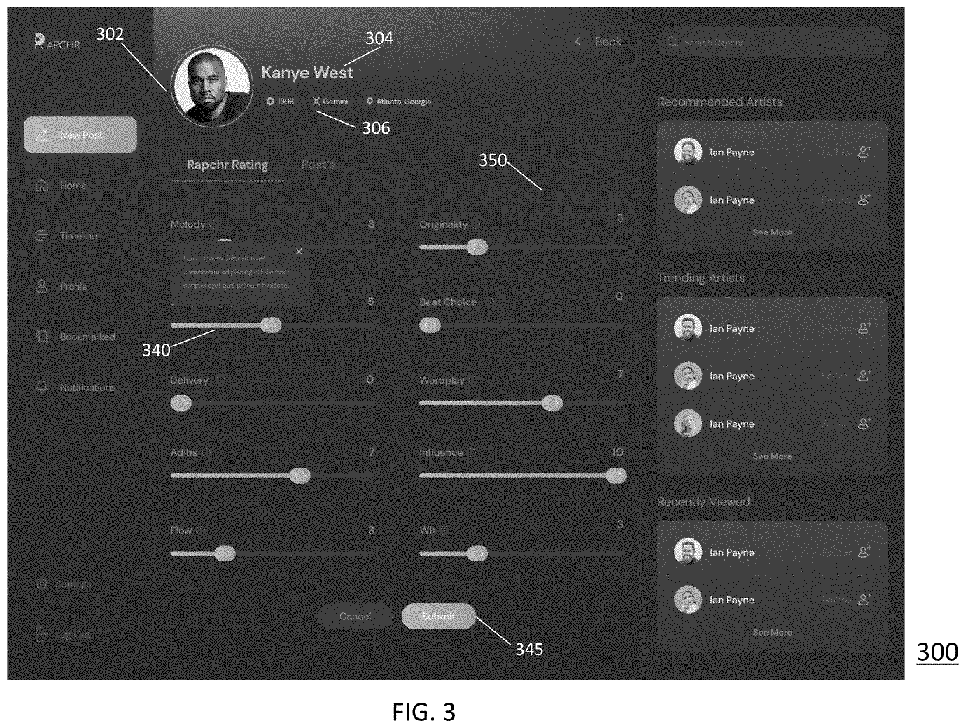

A “Rate” button 245 may be provided to the user to access the ratings page for the subject. FIG. 3 contains a rending of such a page.

### The Rating Interface

Referring to FIG. 3, a ratings interface is shown. Artist profile information may again be presented, including photo 302, name 304, and other biographical information 306 such as birth year, astrological sign, and hometown. A plurality of visual, graphical, and textual indicators may be provided that that provide cues to the user to enter information concerning the subjective interpretations of the artists. The ratings matrix shown in FIG. 2 has been replaced in FIG. 3 with a plurality of graphical sliders 340a-340j, each of which correspond to a particular ratings vector or skillset. An information icon may be provided adjacent each of sliders 340a-340j to provide information to the user on the ratings vector and what the vector encompasses. The user may rate the subject along each vector by dragging the enlarged portion of the slider left or right with an input device associated with a computing device. In embodiments, an input device may comprise a touchscreen display, mouse, keyboard, pointer, and electronic pencil, among others.

The user may continue making selections for each ratings vector and when complete, select the “Submit” button with the input device. The ratings may then be recorded by or in cooperation with the database engine.

Once the user has submitted their ratings with the “Submit” button 345, the rating is immediately calculated to contribute to the average score from all ratings that have been input previously from all users.

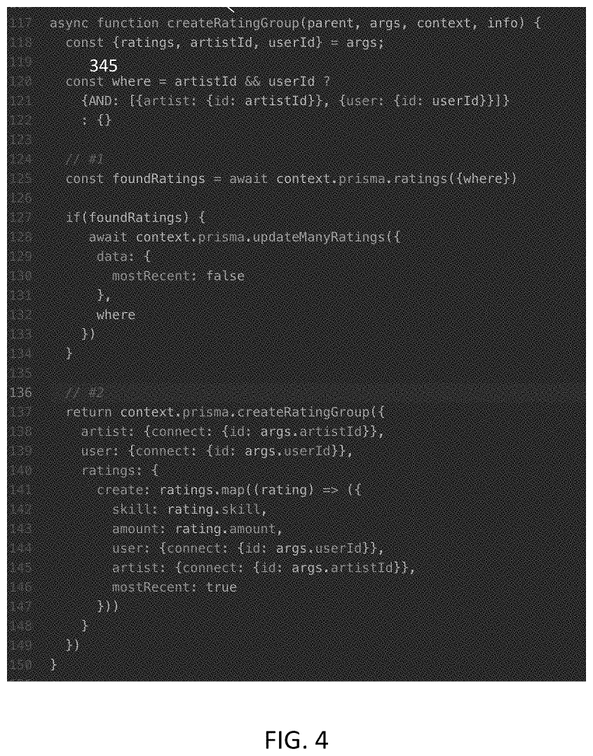

FIG. 4 contains source code snippets that may, when compiled and run on a computing device such as a server computing device, implement specific features of the invention in hardware. When the “Submit” button is activated, an instance of the createRatingGroup (line 117, et seq.) function may be initiated on the ratings engine and cause an instance of a RatingGroup object may be generated and stored by the database engine, and include a field containing the individual Rating objects that are generated. The RatingGroup object is an optional feature that provides a secondary option for querying data from the database engine with a lower performance cost.

It will be appreciated by those of skill in the art that the source code described herein may be implemented in any of application engine, database engine, ratings engine, or any other system component for extending the functionality of that component and providing the described function.

Referring still to FIG. 4, the createRatingGroup function (line 117, et seq.) may first look for previous ratings and changes the mostRecent field to FALSE. This field may be used to implement the date related features (“Last” vs “Total” in FIG. 2). A RatingGroup may then be created (“step 2”), with individual rating objects being created as well, which ratings are based on the 10 skills are integrated through and created in the createRatingGroup function (line 141, et seq.).

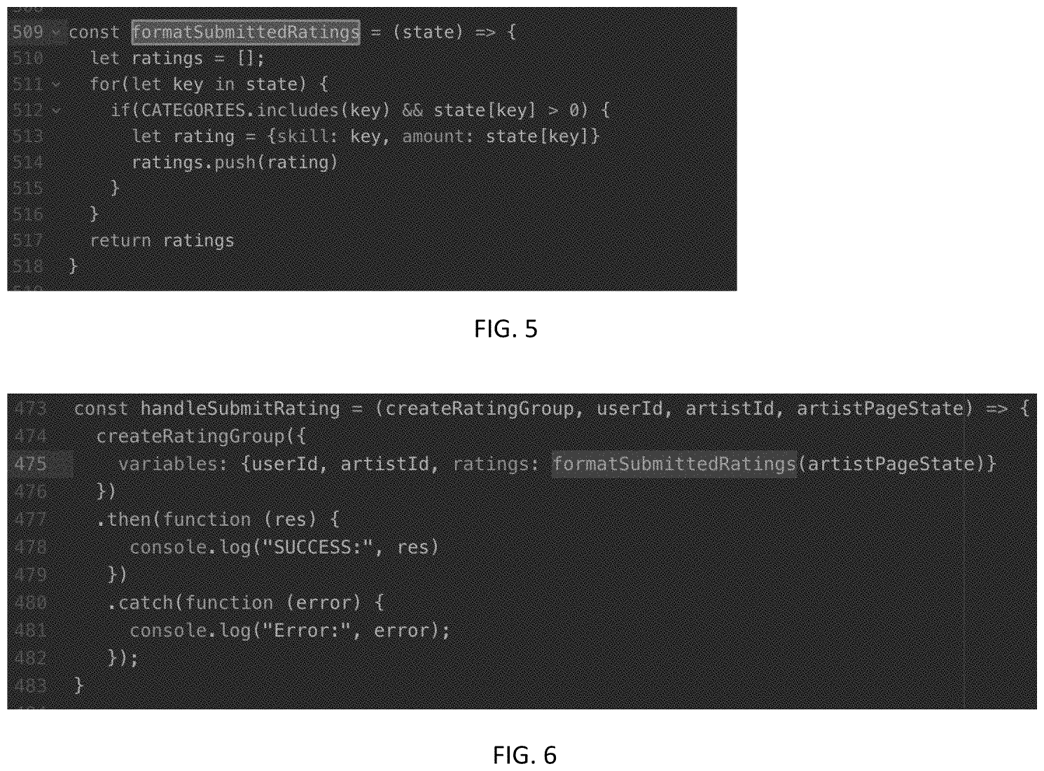

Referring to FIGS. 5 and 6, the formatSubmittedRatings and handleSubmitRating may display the preparation of data that is passed into the ratings engine to handle the creation of our RatingGroup and Rating objects. In embodiments, the logic of FIGS. 4-6 may be implemented in an application engine or distributed across the database and rating engines also.

In embodiments of the invention, a user may submit an unlimited number of rankings, and the rating will be updated accordingly. In embodiments, users may be restricted to updating their rating on an artist once during a defined time period such as every 24 hours.

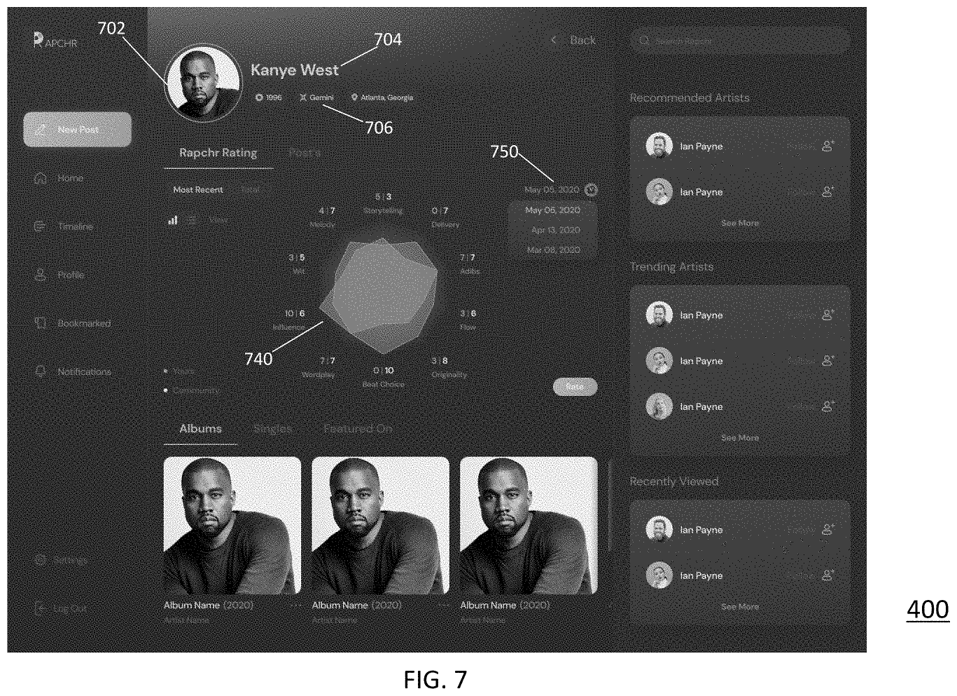

In embodiments of the invention, users may be able to update their ratings after a certain amount of time (e.g., after 24 hours) to capture rich data concerning public opinion over time. FIG. 7 depicts an alternate view of the artist profile page of FIG. 2, showing both ratings over time, and also an alternate graphical display of user rating information.

Similar to the artist page of FIG. 2, artist profile information may again be presented, including photo 702, name 704, biographical information 706, and a plurality of visual, graphical, and textual indicators that provide cues to the user to enter information concerning the subjective interpretations of the artists. Ratings data may be queried from database engine by ratings engine and processed by application engine to present the stylized format shown.

A graph 740 may depict the user rating data for the various ratings vectors. As shown in FIG. 7, user rating data is presented graphically using a double radar or spider chart format with an axis provided for each ratings vector.

Radar charts maybe useful for visualizing comparisons between subjects across multiple vectors. As shown in FIG. 7, a set of user ratings may be overlaid with a set of community ratings. The overlay may provide additional information to the user in the form of commonality and differences between their subjective option and the community as a whole, across all vectors or with respect to one vector in particular.

It will be appreciated that as an alternative to a radar graph, a simple bar graph may be used.

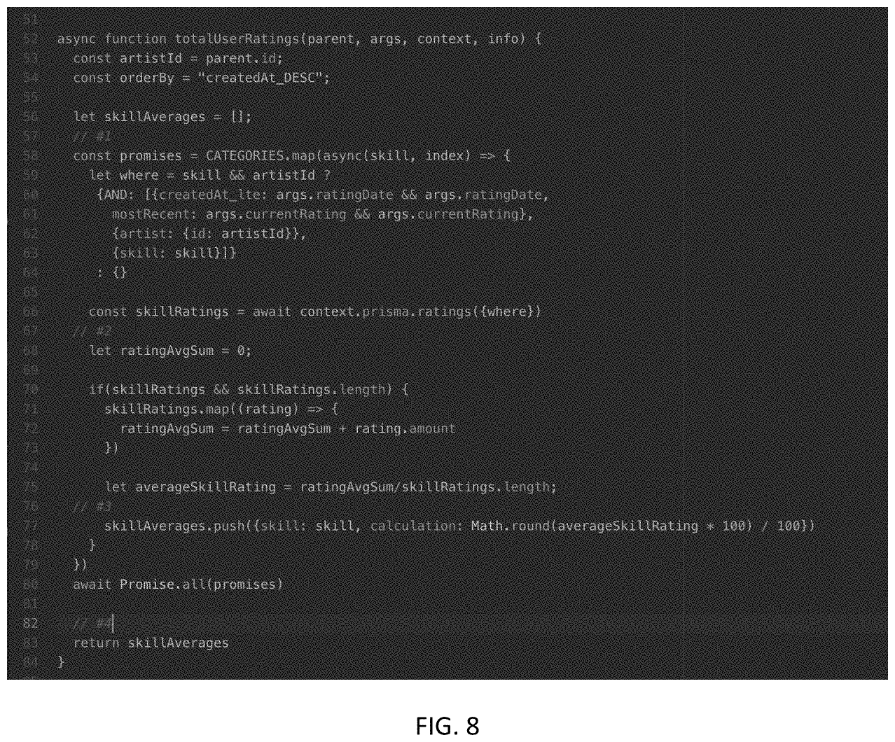

FIG. 8 contains an additional code snippet related to the totalUserRatings function that may be used to present skill ratings. Each skill average here may be presented by the RatingAmount object (or may be looked at as the “skill average”). Each vector (e.g., “Melodies,” “Adlibs,” etc.) is traversed to calculate the individual averages. At line 59, a where object may be used to find the ratings based on the criteria asked for on the front end by the user. At line 60, a createdAt_lte field may facilitate date filtering, while mostRecent may be used to access the latest ratings by a user. An artist field may be used to specify an artist by their ID

At line 67, each rating object that meets the where filtering criteria is retrieved, and the average is then calculated. At line 76, the RatingAmount objects may be generated using the averages that were calculated above. A skill field may also be created along with a calculation field, which may be considered an “average.”

At line 82, the data may then be presented as an array of RatingAmount objects to the user, which may be traversed create a visual representation such as that shown in FIGS. 2 (240) and FIG. 7 (740).

The forgoing source code description is, for example, only to describe the logic of the system, and it should be understood that these details are for this purpose only, and that those users who are skilled in this type of activity can make changes that do not depart from the essence and scope of the invention beyond limited by patent claims.

Referring to FIG. 7, selector 750 may be provided and enable the user to select among various dates that a rating has been entered for the subject. In the example shown in FIG. 7, the data presented is current as of May 5, 2020. However, the user can revisit data from earlier in the same day, Apr. 13, 2020, and Mar. 8, 2020. The user can review their evolution of their subjective opinion over time, as well as the evolution of the community opinion as a whole. By storing the temporal data associated with user ratings, the system can generate rich analytics and reporting that show the changing reputation and status of a subject, quantifying their celebrity over time.

To give an example, on the “Most Recent” tab the community rating averages shown would include only the May 5th date for this user in addition to the rest of the community's most recent submission dates. The “Total” tab may provide an average including both submissions for this user, as well as every submission ever made on the app for this artist regardless of date.

The time feature captures the community's opinions as they currently stand to allow artists to gain recognition and not be weighed down by old opinions. In addition to there being multiple data points to rate, users may be enabled to update their ratings over time to provide a different perspective on the data.

These dates may be based on the dates held by the RatingGroup objects. A user clicking on the date may alter the “createdAt” variable for the skill query in the totalUserRatings resolver shown in FIG. 8. This filter may be configured to limit querying for ratings on or before a given date, unlike createdAt, which may limit to ratings on a specific date.

### Ratings Metric

In embodiments, the user may rate on a scale of 1-10, and the final score for each skillset set may be displayed out of 100%. Each skills percentage represents the average of all user ratings for that skill (skill_score=100*(user1_score+user2_score+user3_score . . . etc.)/number of users who rated the artist).

After each rating, the average scores for each skill for that artist are re-calculated based on the new tallies. Artists skills rating averages will reflect the users most recent rating

In embodiments of the invention, data visualizations may be provided that filter data for an artist. For example, a user may wish to only see ratings for an artist over the past six months since a new album was released. In embodiments, data may be divided into subsets for comparison purposes such as comparing an artist's storytelling between the past three weeks and the same time period last year. Myriad filters and subsets are envisioned as coming within the scope of the invention.

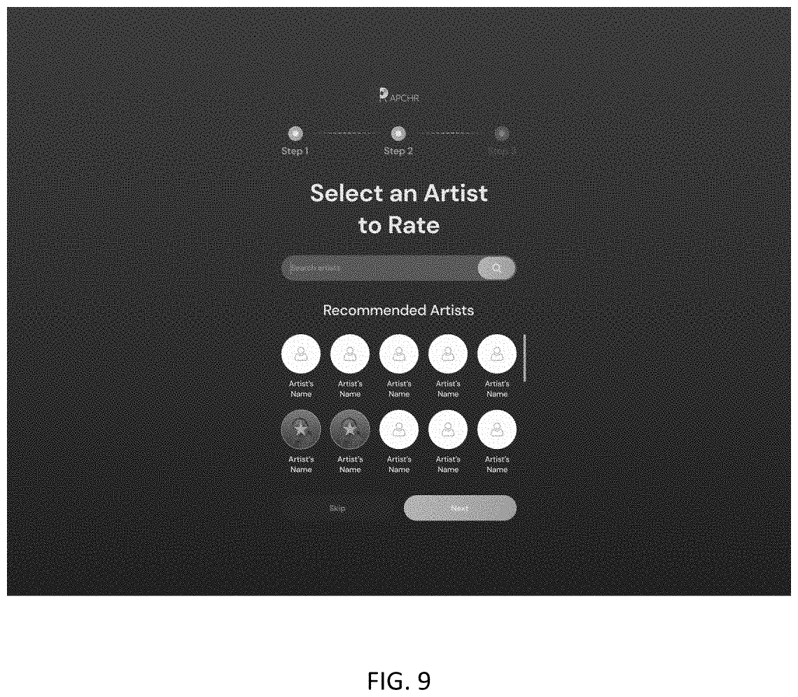

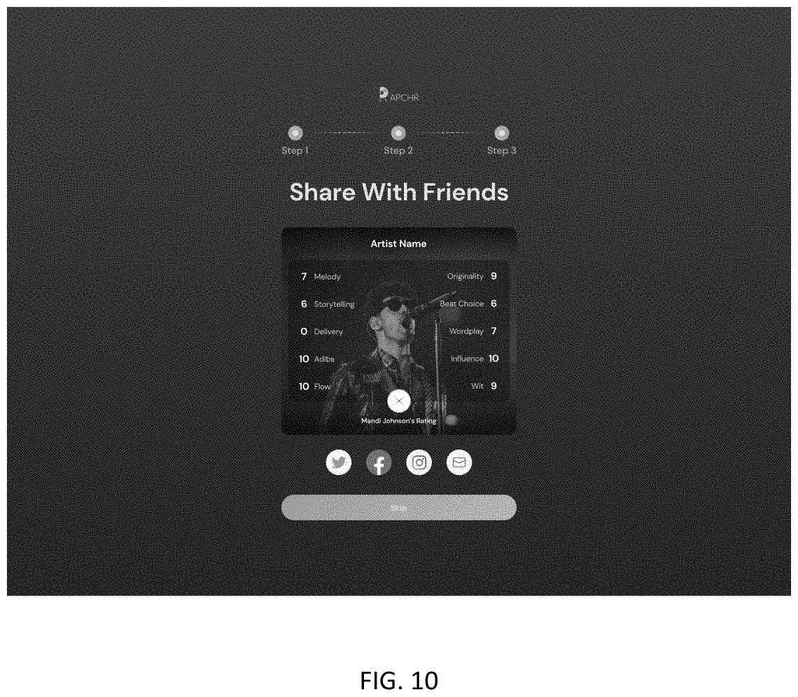

FIGS. 9-10 depict a sample user flow through the rating and visualization features of a user flow through the rating feature. FIG. 9 depicts a sample artist selection page, with a dialog to search for a particular artist. Recommended artists may be generated based on prior user activity and community activity and may be presented graphically to the user as shown in FIG. 7. FIG. 10 depicts a sample window by which a user may share a recent rating, either. through the system to other community users, or via e-mail or social media.

In a preferred embodiment, the system may be configured to enable users to provide and analyze skill rankings for a musical artist specifically, a rap or hip-hop artist.

The individual skills may be defined for users in the system (e.g., on the RANKING SCREEN) or may be left to the user's interpretation. Referring to FIG. 3, a selection of key skills 340 are shown as would be used in a preferred embodiment.

ADLIBS: This characteristic may refer to the performer's ability to generate material seemingly without preparation or “on the fly” and include repeated, improvised sounds, notes or phrases that are commonly used as a distinguishing characteristic of an artist's music.

BEAT CHOICE: This characteristic may refer to the ability of an artist to consistently select musical instrumentals that blend with an artistic style and are also very appealing to an audience.

MELODIES: May describe a rhythmic succession or arrangement of notes sung by an artist to add an aesthetically pleasing layers to the music.

INFLUENCE: This characteristic may refer to the influence the performer has had on other artists, including peers and contemporaries, and subsequent generations of performers. “Influence” of a subject may extend to influence on genres outside the subject's main genre.

FLOW: The rhythms and rhymes of a song's lyrics and how well they interact in harmony with the underlying beat of a song. Flow may include a combination of rhythm, rhyme schemes, and cadence. It can sometimes include elements of delivery including pitch, tune, volume, and breath control.

STORYTELLING: “Storytelling” is the ability of a performer to present a narrative and conjure an image in the listener's mind.

DELIVERY: May refer to how an artist performs their lyrics. It includes any combination of energy, passion, tone, pitch, and volume

WIT: The quality of having clever, perceptive, and astute lyrics

WORDPLAY: The playful use of words meant to amuse and add depth to lyrics. Examples include puns, double entendres, obscure words or references, assonance, complex but cohesive rhyme patterns and other forms of verbal or literary wit.

INGENUITY: The quality of being original and inventive as it relates the creation and application of an artist's skillsets.

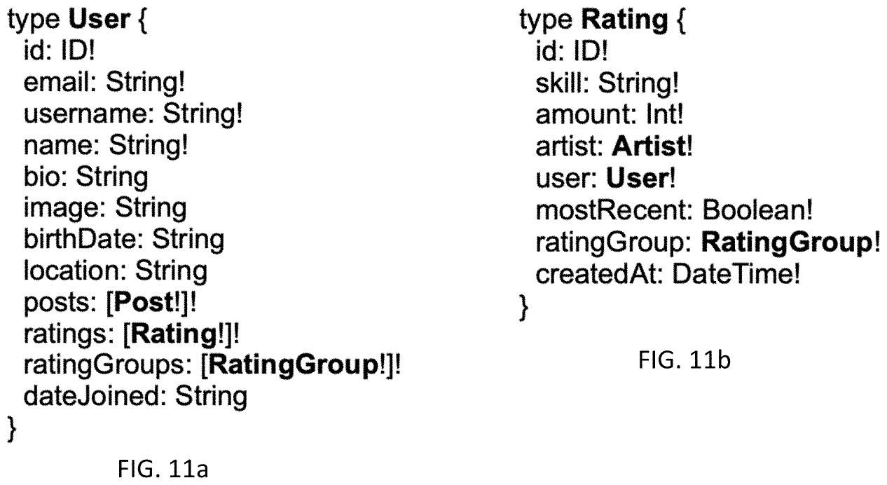

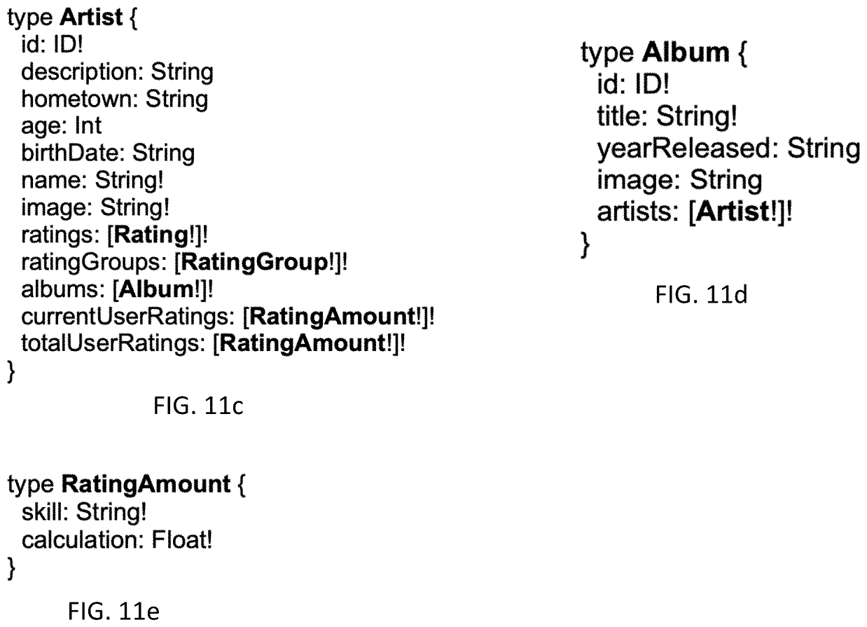

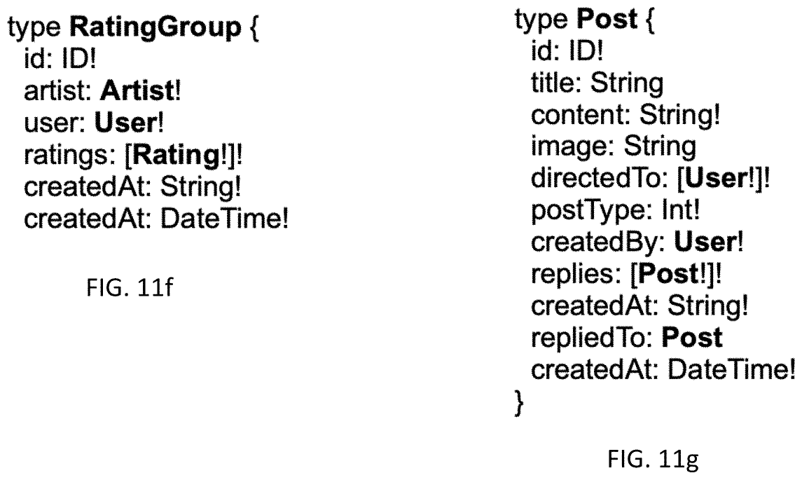

FIG. 11a shows an exemplary User object type, which has been structured as a GraphQL schema for purposes of illustration. The User object type in this example comprises a series of fields representing the User vector. Each user may have an ID field that contains a unique numerical identifier that is used to identify the specific user and represent the user in corresponding objects. A plurality of data fields—here, e-mail, username, name, bio, image, birthdate, location, and datejoined—contain data on an individual user and, in this example, are of a data type “string.” Some fields may be required and are indicated with an exclamation mark (!). These and other objects are preferably stored by database engine under management of an application engine.

As described above, each user may rate an artist, which in embodiments of the invention may generate the Rating object shown in FIG. 11b. A Rating object may contain a unique identifier to link the rating to other objects in the database. The name of the artist being rated may be stored in the required Artist field, and the user posting the rating stored in the required User field. The skill being rated (e.g., storytelling) may be stored as a string type in a skill field and the actual rating stored in the amount field. In the embodiments shown in FIG. 11b, the skill is stored as an integer (e.g., a 1-10 rating), but could be stored as a different metric such as letter ratings, floating point numbers, symbols, or the like. A timestamp when the rating was created may be stored to facilitate the reporting and analysis steps described above. If this particular rating object is the most recent for the artist, a TRUE may be stored in the mostRecent field, and a FALSE otherwise. A required ratingGroup field may be provided to incorporate a skill name and quantity to adds long-term flexibility to the user selection process.

Similar to the user data object, an artist data object may be provided to store information about an artist in the database, including a unique identifier, description, hometown, age, birthdate, name, and image, as shown in FIG. 11c. A ratings array may contain a series of individual ratings objects and preferably, the identification number for each ratings object. Similarly, an array of albums by the artist may contain a series of identification codes indicating individual album objects. Fields for currentUserRatings (this user) and totalUserRatings (all users) may facilitate operation of the resolver.

An album data object FIG. 11d may represent a single work by an artist. The album data object may contain a unique identifier, title, year released, image, and an array data type contain identifiers of the individual artists that recorded the album.

A RatingAmount data object FIG. 11e may contain a single string value representing a skill and a floating point “calculation.”

Whenever ratings are made by a user at one time, each rating by skill name is stored in a ratingGroup (which may hold a maximum of ten ratings corresponding to the 10 different skills).

FIGS. 11f-g depict the RatingGroup and Post objects that may be used with embodiments of the invention as discussed herein.

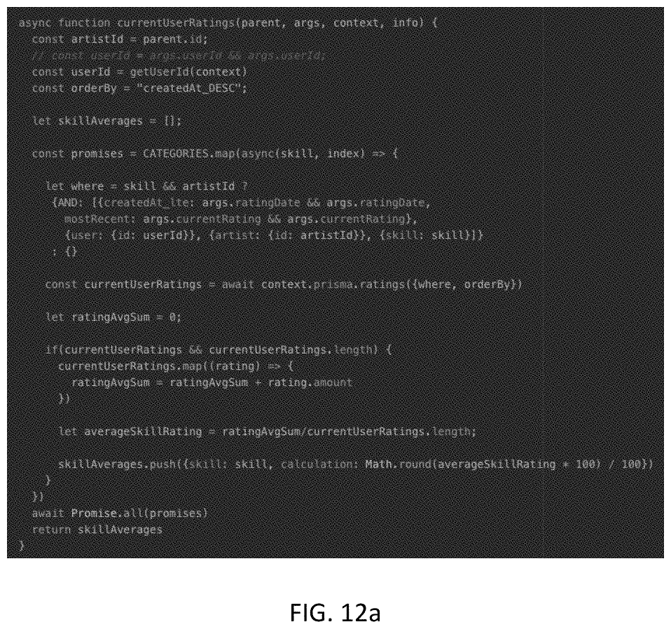

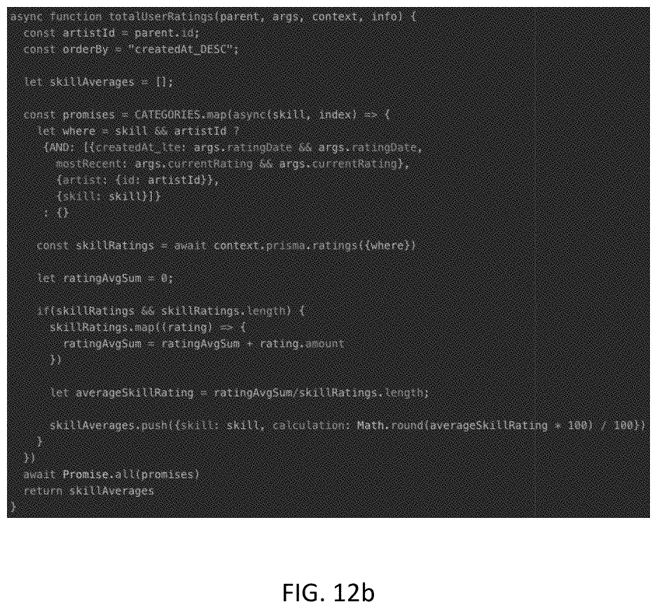

FIGS. 12a-12b contain a screenshots of sample resolvers that may be used with embodiments of the invention. A resolver is a function that populates the data for a single field in a schema, such as by fetching data from a back-end database or a third-party API. Resolvers may work on a per-field basis to return a result for a field when given a parent object, arguments, and the execution context.

FIG. 12a depicts a currentUserRatings resolver, while FIG. 12b depicts the totalUserRatings resolver. When an application engine processes a client query for a particular field (e.g., the May 5, 2020 ratings for a particular subject), the resolver logic may fetch the requested data from the appropriate data source to populate the data field.

The foregoing description of preferred embodiments of the present invention has been provided for illustration and description. It is not intended to be exhaustive or to limit the invention to the precise forms disclosed. Many modifications and variations will be apparent to one of ordinary skill in the relevant arts while remaining within the scope of the appended claims. For example, components may be omitted, interconnected, or disconnected. Steps performed in the embodiments of the invention disclosed can be performed in alternate orders, certain steps can be omitted, and additional steps can be added. The embodiments were chosen and described to best explain the principles of the invention and its practical application, thereby enabling others skilled in the art to understand the invention for various embodiments and with various modifications that are suited to the particular use contemplated. It is intended that the scope of the invention be defined by the claims and their equivalents.

In the examples shown in the figures, user interface elements, data, data graphs and visualizations might be shown in color, as black text on a white background, with a particular shape, or layout. Colors, shadings, shapes, and other visual indicators here are arbitrary and exemplary.

Furthermore, throughout this disclosure, several embodiments were described as containing functions, engines, modules, and/or components. In general, the word module or function, as used herein, refers to logic embodied in hardware or firmware, or to a collection of software instructions, possibly having entry and exit points, written in a programming language, such as, for example, C, C++, or C #, Java, or some other commonly used programming language. A software module may be compiled and linked into an executable program, installed in a dynamic link library, or may be written in an interpreted programming language such as, for example, BASIC, Perl, or Python. It will be appreciated that software modules can be callable from other modules or from themselves, and/or may be invoked in response to detected events or interrupts. Software modules can be stored in any type of computer-readable medium, such as a memory device (e.g., random access, flash memory, and the like), an optical medium (e.g., a CD, DVD, BluRay, and the like), firmware (e.g., an EPROM), or any other storage medium. The software modules may be configured for execution by one or more processors to cause the disclosed computer systems to perform particular operations. It will be further appreciated that hardware modules can be comprised of connected logic units, such as gates and flip-flops, and/or can be comprised of programmable units, such as programmable gate arrays or processors. Generally, the modules described herein refer to logical modules that can be combined with other modules or divided into sub-modules despite their physical organization or storage.

We claim:

1. A data analysis and visualization system for receiving, displaying, and calculating ratings for a subject according to a common and predetermined set of parameters over time, comprising:
one or more servers comprising one or more processors, wherein at least one of the one or more servers is connected to the Internet; and
wherein the system receives from a user computing device, via the Internet, a subject profile request comprising a subject ID;
an application engine configured to receive the subject profile request and subject ID, and retrieve from a database engine, subject profile record associated with the subject ID, the subject profile record comprising one or more ratings vectors, each having an associated value;
wherein the subject profile record is formatted by application engine for display on a user computing device;
wherein the system receives from a user computing device, via the Internet, a subject rating request comprising: (a) a subject ID; (b) one or more ratings vectors; (c) a score for each of the one or more ratings vectors; and (d) time element; and
wherein a ratings engine is configured to cause the subject rating request to be recorded to the database engine and generate, using data from the database engine, an updated value for each ratings vector with an associated time element and to deliver to the user computing device data a graphical depiction of the subject profile.

2. The data analysis and visualization system of claim 1 wherein the ratings engine is further configured to cause the graphical depiction of the subject profile to be limited to ratings vectors that have been updated within a first time window.

3. The data analysis and visualization system of claim 2 wherein the ratings engine is further configured to cause the graphical depiction of the subject profile to further include ratings vectors that have been updated within a second time window.

4. The data analysis and visualization system of claim 1 wherein the application engine is further configured to limit the number of subject profile requests from a particular user that may be recorded within a predetermined time window.

5. The data analysis and visualization system of claim 1 wherein the application engine is further configured to receive a new ratings vector definition from a user and add the same to the database engine.

6. The data analysis and visualization system of claim 1 wherein graphical depiction of the subject profile is one of: a double radar graph, spider graph, bar graph, pie chart, line graph, and scatter plot.

7. The data analysis and visualization system of claim 1 wherein the application engine is further configured to transmit to a user computing device, over the Internet, a plurality of graphical input elements that are configured to populate subject rating request based upon the user's selection.

8. The data analysis and visualization system of claim 7 wherein the plurality of graphical input elements are slider bars.

9. A data analysis and visualization method for receiving, displaying, and calculating ratings for a subject according to a common and predetermined set of parameters over time, comprising:
providing one or more servers comprising one or more processors, wherein at least one of the one or more servers is connected to the Internet; and
wherein the system receives from a user computing device, via the Internet, a subject profile request comprising a subject ID;
providing an application engine configured to receive the subject profile request and subject ID, and retrieve from a database engine, subject profile record associated with the subject ID, the subject profile record comprising one or more ratings vectors, each having an associated value;
formatting the subject profile record for display on a user computing device;
receiving from a user computing device, via the Internet, a subject rating request comprising: (a) a subject ID; (b) one or more ratings vectors; (c) a score for each of the one or more ratings vectors; and (d) time element; and
causing a ratings engine to record the subject rating request in the database engine and generate, using data from the database engine, an updated value for each ratings vector with an associated time element and delivering to the user computing device data a graphical depiction of the subject profile.
